(19) United States
(12) Patent Application Publication
(10) Pub. No.: US 2025/0110021 A1
(43) Pub. Date: Apr. 3, 2025

(54) GAS SENSOR

(71) Applicant: NITERRA CO., LTD., Nagoya-shi (JP)

(72) Inventors: Masashi NOMURA, Nagoya-shi (JP); Motohiko NAKAMURA, Nagoya-shi (JP)

(73) Assignee: NITERRA CO., LTD., Nagoya-shi (JP)

(21) Appl. No.: 18/899,184

(22) Filed: Sep. 27, 2024

(30) Foreign Application Priority Data
Sep. 29, 2023 (JP) 2023-169325
Jul. 10, 2024 (JP) 2024-110689

(51) Int. Cl. G01M 15/10

(52) U.S. Cl. CPC G01M 15/102

(57) ABSTRACT

A gas sensor 10 including: a plate-shaped sensor element 21 extending in an axial-line O direction and having a plurality of electrode pads 21a, 21b at a main surface 20m1, 20m2 on a rear end side thereof; a plurality of plate-shaped metal terminals 71 electrically connected to the respective electrode pads; and a separator 50 having a storage portion 50h which penetrates in the axial-line direction and in which the rear end side of the sensor element and the metal terminals are stored, thus retaining the metal terminals, wherein the electrode pads and the metal terminals are arranged separately from each other in a width direction of the sensor element, and a vibration inhibiting member 80 is provided so as to be close to or in contact with radially inner sides of the metal terminals while including an axis of the separator, as seen in the axial-line direction.

### BACKGROUND

### 1. Field of the Disclosure

The present disclosure relates to a gas sensor suitably used for detecting the gas concentration of a specific gas contained in combustion gas or exhaust gas of a combustor, an internal combustion engine, or the like, for example.

### 2. Description of Related Art

As a gas sensor for detecting the concentration of oxygen or NOx in exhaust gas of an automobile or the like, a gas sensor having a plate-shaped sensor element using a solid electrolyte is known.

This type of gas sensor may be configured such that a plurality of electrode pads arranged in the width direction are provided on the rear-end sides of opposed main surfaces of a plate-shaped sensor element, and metal terminals electrically contact with the respective electrode pads, to take sensor output signals from the sensor element to outside (Patent Document 1).

In the gas sensor in Patent Document 1, the metal terminals are retained in an insulating connector (separator) of a two-divided type. This connector is configured such that the respective metal terminals are stored in box-type housings having the same shape and the housings are fitted to each other and fixed by a metal clamp. Then, when the rear end side of the sensor element is inserted into an insertion hole of the connector, the metal terminals inside the connector electrically contact with electrode pads.

On the rear end side of the connector, the insertion hole has a diameter expanding radially outward in a direction perpendicular to main surfaces of the sensor element as approaching a rearward-facing surface. Thus, the metal terminals led out to the rear end side of the connector are inhibited from interfering with the inner surface of the connector.

[Patent Document 1] Japanese Patent Application Laid-Open (kokai) No. 2014-209104

### 3. Problem(s) to be Solved

However, when the rear end side of the connector has an expanding diameter, the intervals between the connector and the metal terminals become great, and thus it has been found that the metal terminals sway in the connector due to vibration during usage of the gas sensor or the like and are likely to be broken.

### SUMMARY OF THE DISCLOSURE

An object of the present disclosure is to provide a gas sensor configured to inhibit breakage of metal terminals on the rear end side of a separator.

In a first aspect, a gas sensor of the present disclosure is a gas sensor including: a plate-shaped sensor element extending in an axial-line direction and having a plurality of electrode pads at a main surface on a rear end side thereof; a plurality of plate-shaped metal terminals electrically connected to the respective electrode pads; and a separator having a storage portion which penetrates in the axial-line direction and in which the rear end side of the sensor element and the metal terminals are stored, thus retaining the metal terminals, wherein the plurality of electrode pads and the plurality of metal terminals are arranged separately from each other in a width direction of the sensor element, and a vibration inhibiting member is provided so as to be close to (adjacent) or in contact with radially inner sides of the metal terminals while including an axis of the separator, as seen in the axial-line direction.

The metal terminals have plate shapes, and the plate surfaces face the main surfaces of the sensor element. The plate-shaped metal terminals sway in a direction perpendicular to the plate surfaces. Therefore, due to vibration during usage of the gas sensor or the like, the metal terminals sway radially inward (toward the center side of the sensor element) and are likely to be broken.

Accordingly, with this gas sensor, a vibration inhibiting member may be provided so as to be close to or in contact with the radially inner sides of the metal terminals while including the axis of the separator, as seen in the axial-line direction.

Thus, since the vibration inhibiting member is interposed on the radially inner sides of the metal terminals, sway of the metal terminals in the radially inward direction is inhibited or reduced, whereby breakage of the metal terminals can be inhibited.

In the gas sensor according to the first aspect of the present disclosure, the storage portion may have a diameter-expanding portion whose diameter expands toward a direction perpendicular to the main surface as approaching a rearward-facing surface of the separator, and the vibration inhibiting member may be provided on an inner side of the diameter-expanding portion.

With this gas sensor, since the diameter-expanding portion whose diameter expands as approaching the rearward-facing surface of the separator is provided, the vibration inhibiting member can be easily inserted to the inner side of the diameter-expanding portion.

A gas sensor of a second aspect of the present disclosure is a gas sensor including: a plate-shaped sensor element extending in an axial-line direction and having a plurality of electrode pads at a main surface on a rear end side thereof; a plurality of plate-shaped metal terminals electrically connected to the respective electrode pads; a separator having a storage portion which penetrates in the axial-line direction and in which the rear end side of the sensor element and the metal terminals are stored, thus retaining the metal terminals; and an elastic grommet provided on a rear end side of the separator separately from the separator, wherein the grommet has a grommet hole in which rear ends of the metal terminals and lead wires connected to the rear ends are inserted, the plurality of electrode pads and the plurality of metal terminals are arranged separately from each other in a width direction of the sensor element, and a vibration inhibiting member is provided, between the separator and the grommet, so as to be close to or in contact with radially inner sides of the metal terminals while including an axis of the separator, as seen in the axial-line direction.

The metal terminals have plate shapes and the plate surfaces face the main surfaces of the sensor element. The plate-shaped metal terminals sway in a direction perpendicular to the plate surfaces. Therefore, due to vibration during usage of the gas sensor or the like, the metal terminals sway radially inward (toward the center side of the sensor element) and are likely to be broken.

Accordingly, with this gas sensor, a vibration inhibiting member may be provided, between the separator and the grommet, so as to be close to or in contact with the radially inner sides of the metal terminals while including the axis of the separator, as seen in the axial-line direction.

Thus, since the vibration inhibiting member is interposed on the radially inner sides of the metal terminals, sway of the metal terminals in the radially inward direction is inhibited or reduced, whereby breakage of the metal terminals can be inhibited.

In the gas sensor according to the second aspect of the present disclosure, the storage portion may have a diameter-expanding portion whose diameter expands toward a direction perpendicular to the main surface as approaching a rearward-facing surface of the separator.

With this gas sensor, since the diameter-expanding portion whose diameter expands as approaching the rearward-facing surface of the separator is provided, the vibration inhibiting member can be easily inserted to the inner side of the diameter-expanding portion.

In the gas sensor of the present disclosure, a radially-outward-facing surface of the vibration inhibiting member may contact with the radially inner sides of the metal terminals.

With this gas sensor, when the vibration inhibiting member contacts with the radially inner sides of the metal terminals, sway of the metal terminals in the radially inward direction can be further inhibited or reduced.

In the gas sensor of the present disclosure, the diameter-expanding portion may have storage grooves which extend in the axial-line direction and in which the metal terminals are respectively stored, a radially-outward-facing surface of the vibration inhibiting member may have projections at respective positions corresponding to the storage grooves, and the projections may be put into the storage grooves, and the metal terminals may be respectively retained between the projections and the storage grooves.

With this gas sensor, each metal terminal is retained in a narrow space between the projection and the storage groove.

Thus, each metal terminal can be assuredly retained between the projection and the storage groove, whereby breakage of the metal terminal can be further inhibited. Sway of the metal terminal in the radially inward direction is inhibited by a frontward-facing surface of the projection coming close to or into contact with the radially inner side of the metal terminal.

In the gas sensor of the present disclosure, a radially-outward-facing surface of the vibration inhibiting member may have, at least partially, a taper shape whose diameter expands toward a rear end side along the diameter-expanding portion.

With this gas sensor, the taper surface of the vibration inhibiting member surface-to-surface contacts with the diameter-expanding portion, so that the vibration inhibiting member is further firmly fixed on the inner side of the diameter-expanding portion.

In the gas sensor of the present disclosure, a radially-outward-facing surface of the vibration inhibiting member may have recesses in which the metal terminals are respectively stored.

With this gas sensor, each metal terminal can be assuredly retained in the recess, whereby breakage of the metal terminal can be further inhibited. Sway of the metal terminal in the radially inward direction is inhibited by an outward-facing surface of the recess coming close to or into contact with the radially inner side of the metal terminal.

The present disclosure makes it possible to provide a gas sensor configured to inhibit breakage of metal terminals on the rear end side of a separator.

Additional features and advantages of the present disclosure may be described further below. This summary section is meant merely to illustrate certain features of the disclosure, and is not meant to limit the scope of the disclosure in any way. The failure to discuss a specific feature or embodiment of the disclosure, or the inclusion of one or more features in this summary section, should not be construed to limit the claims.

### BRIEF DESCRIPTION OF THE DRAWINGS

The figures contained herein are provided only by way of example and not by way of limitation.

FIG. 1 Sectional view of a gas sensor according to a first embodiment of the present disclosure.

FIG. 2 Perspective view showing a separator.

FIG. 3 Sectional view taken along line A-A in FIG. 2.

FIG. 4 Perspective view showing a metal terminal.

FIG. 5 Perspective view of a vibration inhibiting member according to the first embodiment of the present disclosure.

FIG. 6 Plan view showing the separator and the vibration inhibiting member as seen in the axial-line direction.

FIG. 7 Sectional view of a gas sensor according to a second embodiment of the present disclosure.

FIG. 8 Perspective view of a vibration inhibiting member according to the second embodiment of the present disclosure.

FIG. 9 Plan view showing the separator and the vibration inhibiting member as seen in the axial-line direction.

FIG. 10 Partially enlarged sectional view showing a modification of the gas sensor according to the first embodiment of the present disclosure.

### DESCRIPTION OF REFERENCE NUMERALS

Reference numerals used to identify various features in the drawings include, but are not limited to, the following:
10, 10B gas sensor
20 sensor element
20m1, 20m2 main surface of the sensor element
21a, 21b electrode pad
47 grommet
47a grommet hole
48 lead wire
50, 50B separator
50g storage groove
50h, 50hB storage portion
50s diameter-expanding portion
71 metal terminal
80, 180 vibration inhibiting member
80f, 180f radially-outward-facing surface of the vibration inhibiting member
80p projection
180g recess
O axial line

### DETAILED DESCRIPTION

Hereinafter, embodiments of the present disclosure will be described with reference to the drawings.

It is to be understood that both the foregoing general description and the following detailed description are exemplary and are intended to provide further explanation of the claims. Accordingly, various changes, modifications, and equivalents of the methods, apparatuses, and/or systems described herein will be apparent to those of ordinary skill in the art. Moreover, descriptions of well-known functions and constructions may be omitted for increased clarity and conciseness.

The terms used in the description are intended to describe embodiments only, and shall by no means be restrictive. Unless clearly used otherwise, expressions in a singular form include a meaning of a plural form. In the present description, an expression such as “comprising” or “including” is intended to designate a characteristic, a number, a step, an operation, an element, a part or combinations thereof, and shall not be construed to preclude any presence or possibility of one or more other characteristics, numbers, steps, operations, elements, parts or combinations thereof.

If used herein, “about,” “approximately,” “substantially,” and “significantly” will be understood by a person of ordinary skill in the art and will vary in some extent depending on the context in which they are used. If there are uses of the term which are not clear to persons of ordinary skill in the art given the context in which it is used, “about” and “approximately” will mean plus or minus ≤10% of particular term, and “substantially” and “significantly” will mean plus or minus >10% of the particular term.

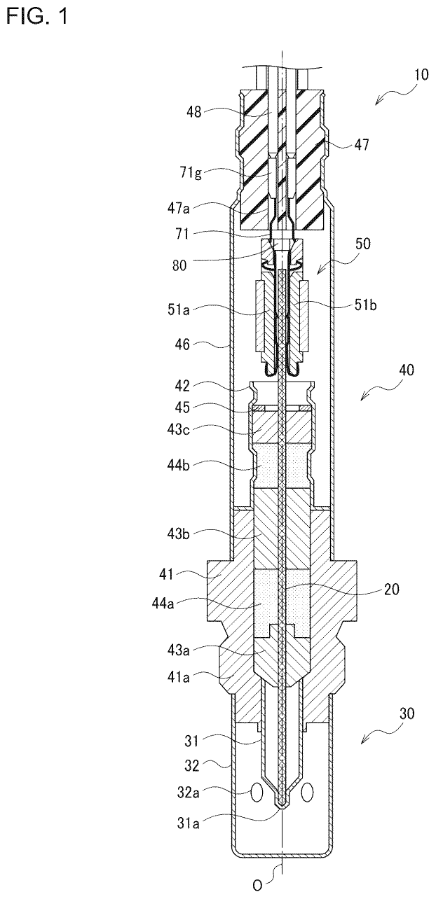

First, with reference to FIG. 1 to FIG. 6, a gas sensor 10 according to the first embodiment of the present disclosure will be described.

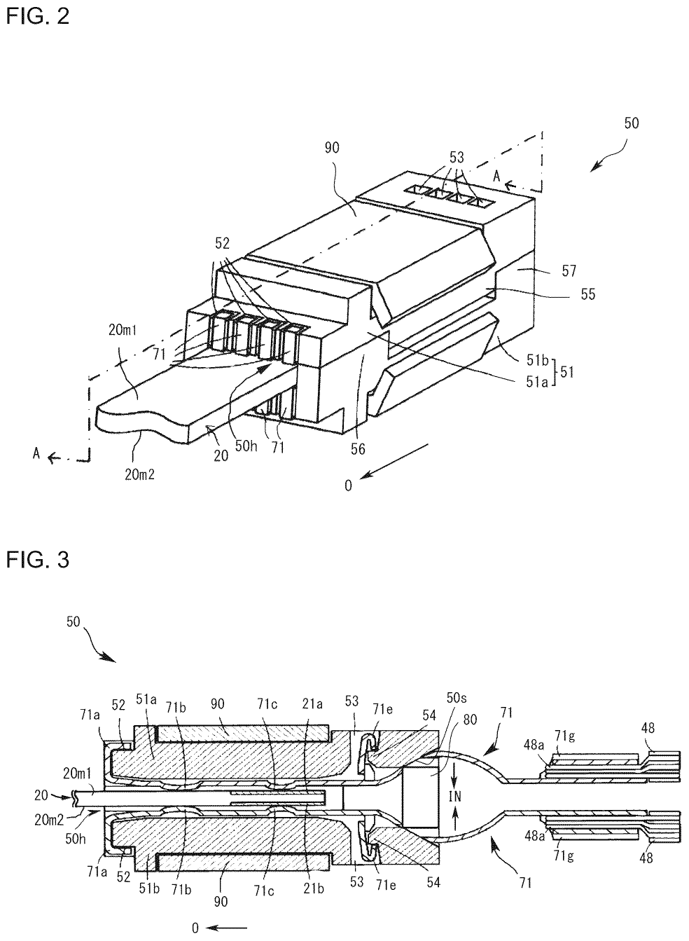

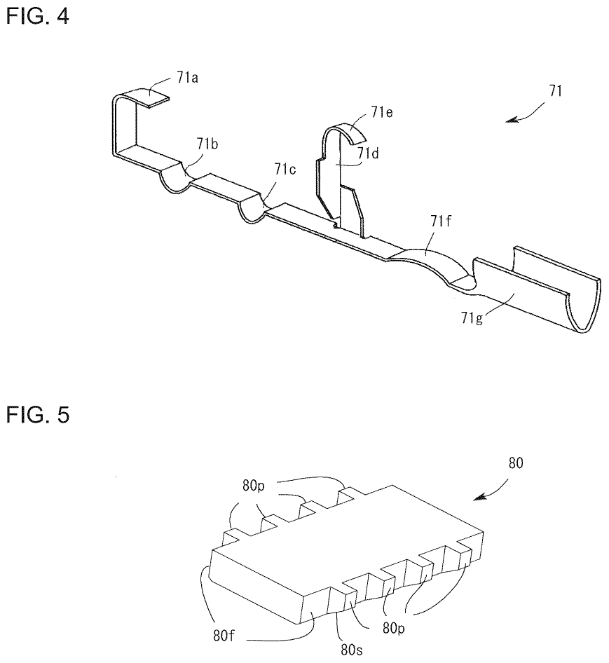

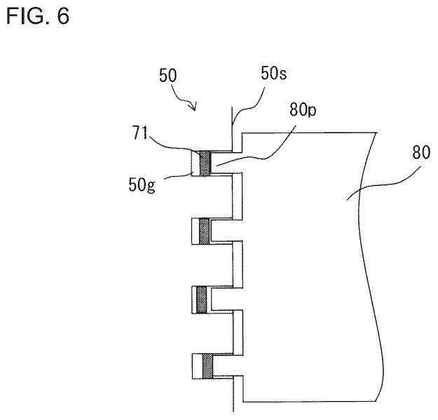

FIG. 1 is a sectional view along the axial-line O direction of a gas sensor (sensor) 10 according to a first embodiment of the present disclosure. FIG. 2 is a perspective view showing a separator 50. FIG. 3 is a sectional view taken along line A-A in FIG. 2. FIG. 4 is a perspective view showing a metal terminal 71. FIG. 5 is a perspective view of a vibration inhibiting member 80. FIG. 6 is a plan view showing the separator 50 and the vibration inhibiting member 80 as seen in the axial-line O direction.

As shown in FIG. 1, the gas sensor 10 includes a sensor element 20 which measures a specific gas component in a measurement target gas, a protector 30 for protecting a front end of the sensor element 20, and a sensor assembly 40 including the separator 50 which stores the rear end side of the sensor element 20. The gas sensor 10 is, for example, attached to an exhaust pipe of a vehicle and is used for measuring a gas component such as NOx or O₂ contained in the measurement target gas (exhaust gas).

The sensor element 20 is a plate-shaped element having a long thin size and extending in the axial-line-O direction, and is formed by laminating layers such as a ceramic substrate made of an oxygen ion conductive solid electrolyte layer of zirconia (ZrO₂) or the like. An end on the protector 30 side of the sensor element 20 is referred to as a front end, and an end on the separator 50 side of the sensor element 20 is referred to as a rear end.

A plurality of electrode pads 21a, 21b (FIG. 3) are formed at main surfaces 20m1, 20m2 (FIG. 2 and FIG. 3) on the rear end side of the sensor element 20.

Specifically, as shown in FIG. 3, at one main surface 20m1 of the sensor element 20, the plurality of electrode pads 21a are arranged separately from each other in the width direction of the sensor element 20, and similarly, at the other main surface 20m2 of the sensor element 20, the plurality of electrode pads 21b are arranged separately from each other in the width direction of the sensor element 20.

The plurality of electrode pads may be arranged at only one main surface 20m1 or 20m2 of the sensor element 20.

The electrode pads 21a, 21b are used for applying voltage to the sensor element 20, for outputting detection signals of the sensor element 20, or for energizing a heater in a case where the sensor element 20 has a heater.

As shown in FIG. 1, the protector 30 is provided so as to surround the front end of the sensor element 20. The protector 30 includes an inner protector 31 covering the front end of the sensor element 20, and an outer protector 32 covering the inner protector 31. The inner protector 31 is formed in a tubular shape and has, at the front end of the sensor element 20, an inner gas introduction hole 31a through which the measurement target gas is introduced. The outer protector 32 is formed in a bottomed tubular shape and has, in a side surface, outer gas introduction holes 32a through which the measurement target gas is introduced. The inner protector 31 and the outer protector 32 are made of metal such as SUS, for example.

The sensor assembly 40 includes a metal shell 41 made of metal, an inner casing 42 and an outer casing 46 having cylindrical shapes and welded and fixed to the metal shell 41, and the separator 50 connected to the rear end of the sensor element 20.

The metal shell 41 is attached to, for example, an exhaust pipe of a vehicle, via an external thread part 41a. Inside the inner casing 42, a plurality of ceramic sleeves 43a to 43c, and powder filled layers 44a, 44b such as talc provided between the ceramic sleeves 43a, 43b and between the ceramic sleeves 43b, 43c, are sealed in a state of being held between a metal ring 45 and an inner wall of the metal shell 41.

The outer casing 46 covers the inner casing 42, the sensor element 20, and the separator 50. An opening of the rear end side of the outer casing 46 is closed by a grommet 47 made of rubber. A lead wire 48 is connected to a connection portion 71g (FIG. 4) on the rear end side of the metal terminal 71 by crimping or the like, and the lead wire 48 passes through a grommet hole 47a penetrating the grommet 47 in the axial-line-O direction, so as to be led to the outside from the rear end of the grommet 47.

In the grommet hole 47a, the connection portion 71g of the metal terminal 71 and the lead wire 48 are inserted.

Next, the separator 50 will be described. As shown in FIG. 2, the separator 50 includes a first member 51a and a second member 51b made of ceramic such as an alumina sintered body, and a clamp 90 which may be made of metal and which clamps and fixes the first member 51a and the second member 51b.

Each metal terminal 71 is retained at the first member 51a or the second member 51b, and the metal terminals 71 are arranged so as to contact with the electrode pads 21a, 21b of the sensor element 20 in a one-to-one opposed manner.

At each of the first member 51a and the second member 51b, four metal terminals 71 are retained so as to be arranged in the width direction perpendicular to the longitudinal direction (=axial-line-O direction) of the metal terminals 71. The first member 51a and the second member 51b have the same box-type shape, and therefore the same components thereof are denoted by the same reference characters in the description. The first member 51a and the second member 51b are collectively referred to as a housing 51.

The housing 51 includes a storage portion 50h penetrating in the axial-line-O direction, four engagement grooves 52 with which the front end sides of the metal terminals 71 are engaged, four insertion holes 53 into which erected portions 71d at center parts of the metal terminals 71 are inserted, and engagement portions 54 which are formed in the insertion holes 53 and with which the metal terminals 71 are engaged.

The housing 51 has a projection 55 at a side surface on one side in the width direction across the sensor element 20, and has, at the other side surface, restriction members 56, 57 for restricting the thickness-direction distance between the first member 51a and the second member 51b (see FIG. 2). The projection 55 is inserted into a recess between the restriction member 56 and the restriction member 57 of the housing 51 on the opposite side, thus restricting the positions of the first member 51a and the second member 51b in the thickness direction relative to each other.

As shown in FIG. 4, the metal terminal 71 is a member made of metal and retained by the housing 51 at a position one-to-one opposed to each electrode pad 21a, 21b of the sensor element 20, and has a front end 71a having a bent shape to be engaged with the engagement groove 52, a protrusion 71b bent and protruding toward the sensor element 20, a contact portion 71c bent and protruding toward the sensor element 20 so as to contact with each electrode pad 21a, 21b, the erected portion 71d to be inserted into the insertion hole 53, a bent portion 71f to be led to the outside of the separator 50, and the connection portion 71g to which a plurality of wire elements 48a of the lead wire 48 are crimped and retained outside the separator 50.

The protrusion 71b and the contact portion 71c are arranged along the longitudinal direction of the metal terminal 71, and the contact portion 71c is located closer to the connection portion 71g than the protrusion 71b is. The protrusion 71b and the contact portion 71c are formed to be elastically deformable. The erected portion 71d has an engagement portion 71e having a bent shape to be engaged with the engagement portion 54.

The contact portion 71c of the metal terminal 71 retained at the first member 51a contacts with the electrode pad 21a of the sensor element 20 in a one-to-one opposed manner, and the contact portion 71c of the metal terminal 71 retained at the second member 51b contacts with the electrode pad 21b of the sensor element 20 in a one-to-one opposed manner (FIG. 3).

On the other hand, as shown in FIG. 3, the electrode pads 21a, 21b are formed over a range from the rear end of the sensor element 20 to a position between the contact portion 71c and the protrusion 71b.

As shown in FIG. 2, the clamp 90 is formed by bending a plate-shaped metal, and has an elastic force that can press the first member 51a and the second member 51b in directions to approach each other while clamping them. When the first member 51a and the second member 51b are clamped with the elastic force, the restriction members 56, 57 of the first member 51a contact with the second member 51b, and the restriction members 56, 57 of the second member 51b contact with the first member 51a. Thus, the distance between the first member 51a and the second member 51b is fixed.

When the clamp 90 clamps the first member 51a and the second member 51b in a state in which the sensor element 20 and the metal terminals 71 are sandwiched between the first member 51a and the second member 51b such that the contact portions 71c of the metal terminals 71 are opposed to the electrode pads 21a, 21b of the sensor element 20, the protrusions 71b and the contact portions 71c are elastically deformed by the pressing force from the clamp 90, so that the sensor element 20 is held therebetween and fixed.

At this time, since the elastically deformed protrusion 71b and contact portion 71c press the sensor element 20, the sensor element 20 can be assuredly held therebetween and fixed. In addition, since the contact portion 71c is elastically deformed, electric contact between the contact portion 71c and each electrode pad 21a, 21b can be assuredly kept.

Next, features of the present disclosure will be described.

First, as shown in FIG. 3, the separator 50 includes the storage portion 50h penetrating in the axial-line-O direction, and the storage portion 50h stores the rear end side of the sensor element 20 and the metal terminals 71.

More specifically, the storage portion 50h has, at the front end surface of the housing 51, a rectangular opening slightly larger than the outer shape of the sensor element 20, and communicates with the insertion holes 53 on the rear end side. The storage portion 50h may be an insertion hole having openings only at the front end and the rear end of the housing 51.

In this example, the storage portion 50h is formed by recessing parts of the opposed surfaces of the first member 51a and the second member 51b.

Further, the storage portion 50h has a diameter-expanding portion 50s whose diameter expands toward a direction (up-down direction in FIG. 3) perpendicular to the two main surfaces 20m1, 20m2 of the sensor element 20 as approaching the rearward-facing surface of the separator 50.

The wording “expanding toward the direction perpendicular to the main surfaces 20m1, 20m2” means that the expanding direction has a direction component perpendicular to the main surfaces 20m1, 20m2, and includes a case where the degree of diameter expansion of the diameter-expanding portion 50s is different among locations. Examples include a case where the diameter-expanding portion 50s is not parallel to the main surfaces 20m1, 20m2, a case where the diameter-expanding portion 50s has a curved surface, and a case where the diameter-expanding portion 50s is parallel to the main surfaces 20m1, 20m2 but the front edge or the rear edge of the diameter-expanding portion 50s is not parallel to the main surfaces 20m1, 20m2 (lengths or positions of segments appearing when the diameter-expanding portion 50s is cut along the main surfaces 20m1, 20m2 are different from each other).

The metal terminals 71 have plate shapes and the plate surfaces face the main surfaces 20m1, 20m2 of the sensor element 20. The plate-shaped metal terminals 71 sway in a direction perpendicular to the plate surfaces. Therefore, due to vibration during usage of the gas sensor 10 or the like, the metal terminals 71 sway radially inward (toward the center side of the sensor element 20, i.e., IN direction in FIG. 3) and are likely to be broken.

Accordingly, a vibration inhibiting member 80 is provided so as to be close to or in contact with the radially inner sides of the metal terminals 71 while including the axis of the separator 50, as seen in the axial-line-O direction.

Thus, since the vibration inhibiting member 80 is interposed on the radially inner sides of the metal terminals 71, sway of the metal terminals 71 in the radially inward direction (IN direction in FIG. 3) is inhibited or reduced, whereby breakage of the metal terminals 71 can be inhibited. Stated differently, the vibration inhibiting member 80 is provided so as to be close to or in contact with the radially inner sides of the metal terminals 71 while including the axis of the separator 50 so as to inhibit or reduce sway of the metal terminals 71 in the radially inward direction (IN direction in FIG. 3).

Here, in an example shown in FIG. 5, the vibration inhibiting member 80 is made of an insulating material such as ceramic, heat-resistant rubber, or engineering plastic, and has a substantially rectangular plate shape.

On each of radially-outward-facing surfaces 80f opposite to each other of the vibration inhibiting member 80, four projections 80p are formed at equal intervals, so that the outlines near the surfaces 80f have recess and projection shapes.

As shown in FIG. 6, in this example, the diameter-expanding portion 50s of the separator 50 has four storage grooves 50g which extend in the axial-line-O direction and in which the metal terminals 71 are respectively stored.

The projections 80p of the vibration inhibiting member 80 are respectively formed at positions corresponding to the storage grooves 50g.

Therefore, when the vibration inhibiting member 80 is placed on the inner side of the diameter-expanding portion 50s such that the projections 80p are put into the corresponding storage grooves 50g, each metal terminal 71 is retained in a narrow space between the projection 80p and the storage groove 50g.

Thus, each metal terminal 71 can be assuredly retained between the projection 80p and the storage groove 50g, whereby breakage of the metal terminal 71 can be further inhibited. Sway of the metal terminal 71 in the radially inward direction is inhibited by a frontward-facing surface of the projection 80p coming close to or into contact with the radially inner side of the metal terminal 71.

In the example shown in FIG. 6, the projections 80p of the vibration inhibiting member 80 are meshed with the storage grooves 50g of the diameter-expanding portion 50s of the separator 50, whereby the vibration inhibiting member 80 is firmly fixed on the inner side of the diameter-expanding portion 50s.

Further, as shown in FIG. 5, the radially-outward-facing surface (an outer surface of the projection 80p also forms the radially-outward-facing surface) 80p of the vibration inhibiting member 80 partially may have a taper surface 80s whose diameter expands toward the rear end side along the diameter-expanding portion 50s. Thus, the taper surface 80s surface-to-surface contacts with the diameter-expanding portion 50s, so that the vibration inhibiting member 80 is further firmly fixed on the inner side of the diameter-expanding portion 50s.

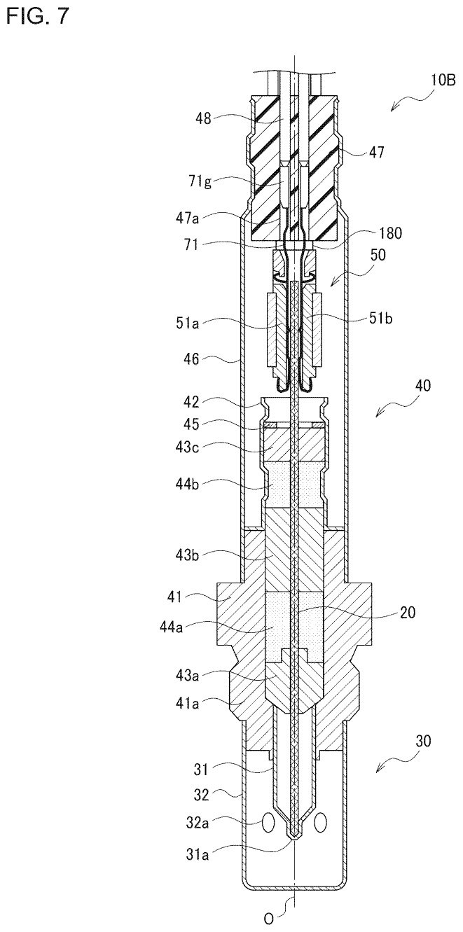

Next, with reference to FIG. 7 to FIG. 9, a gas sensor 10B according to the second embodiment of the present disclosure will be described.

The gas sensor 10B according to the second embodiment is the same as the gas sensor 10 according to the first embodiment except that a vibration inhibiting member 180 is different. Therefore, the same constituent parts are denoted by the same reference characters and the description thereof is omitted.

As shown in FIG. 7, in the gas sensor 10B, the vibration inhibiting member 180 is held between the separator 50 and the grommet 47. Specifically, the vibration inhibiting member 180 is retained between the separator 50 and the grommet 47 by being pressed toward the separator 50 side by the grommet 47.

In the second embodiment, the vibration inhibiting member 180 is provided, between the separator 50 and the grommet 47, so as to be close to or in contact with the radially inner sides of the metal terminals 71 while including the axis of the separator 50, as seen in the axial-line O direction.

Thus, since the vibration inhibiting member 180 is interposed on the radially inner sides of the metal terminals 71, sway of the metal terminals 71 in the radially inward direction (IN direction in FIG. 3) is inhibited or reduced, whereby breakage of the metal terminals 71 can be inhibited.

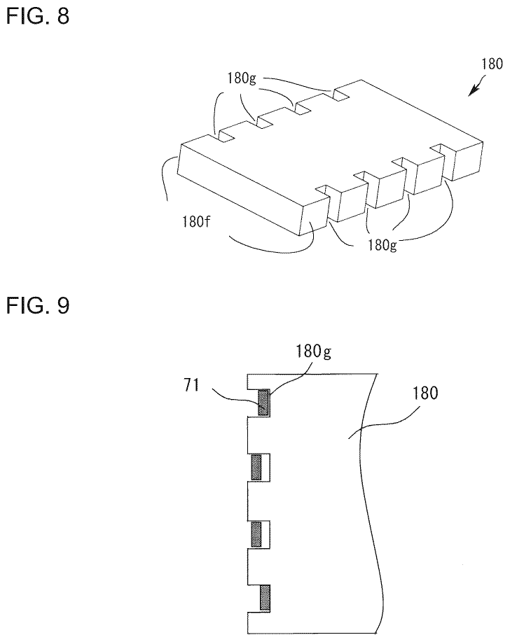

Here, in an example shown in FIG. 8, the vibration inhibiting member 180 is made of an insulating material such as ceramic, heat-resistant rubber, or engineering plastic, and has a substantially rectangular shape.

On each of radially-outward-facing surfaces 180f opposite to each other of the vibration inhibiting member 180, four recesses 180g are formed at equal intervals, so that the outlines near the surfaces 180f have recess and projection shapes.

As shown in FIG. 9, in this example, each metal terminal 71 is retained in the recess 180g of the vibration inhibiting member 180, between the separator 50 and the grommet 47.

Thus, each metal terminal 71 can be assuredly retained in the recess 180g, whereby breakage of the metal terminal 71 can be further inhibited. Sway of the metal terminal 71 in the radially inward direction is inhibited by an outward-facing surface of the recess 180g coming close to or into contact with the radially inner side of the metal terminal 71.

The present disclosure is not limited to the above embodiments and includes various modifications and equivalents encompassed in the idea and the scope of the present disclosure.

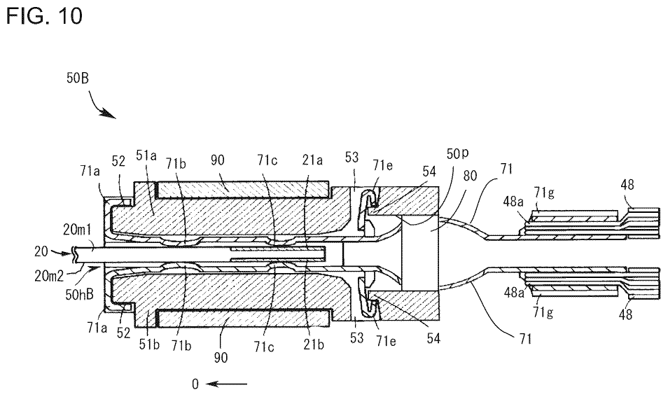

For example, as shown in FIG. 10, in the gas sensor according to the first embodiment, a storage portion 50hB of a separator 50B may not have the diameter-expanding portion. For example, the separator 50B in FIG. 10 has a straight portion 50p parallel to the main surfaces 20m1, 20m2, on the rear end side of the storage portion 50hB.

FIG. 10 is a partially enlarged sectional view around the separator 50B and corresponds to FIG. 3.

Similarly, also in the gas sensor according to the second embodiment, the storage portion of the separator may not have the diameter-expanding portion.

In another example, the shape of the radially-outward-facing surfaces opposite to each other of the vibration inhibiting member may be a flat surface, instead of recess and projection shapes. In this case, as shown in FIG. 6, the storage grooves 50g are provided to the diameter-expanding portion 50s of the separator 50, and the flat surface of the vibration inhibiting member is brought into contact with protruding portions between the storage grooves 50g.

The separator 50 is not limited to the two-divided box shape and may be a tubular shape such as a cylindrical shape.

The disclosure has been described in detail with reference to the above embodiments. However, the disclosure should not be construed as being limited thereto. It should further be apparent to those skilled in the art that various changes in form and detail of the disclosure as shown and described above may be made. It is intended that such changes be included within the spirit and scope of the claims appended hereto.

This application is based on Japanese Patent Application No. 2023-169325 filed Sep. 29, 2023 and Japanese Patent Application No. 2024-110689 filed Jul. 10, 2024, the disclosures of which are incorporated herein by reference their entirety.

What is claimed is:

1. A gas sensor comprising:
a plate-shaped sensor element extending in an axial-line direction and having a plurality of electrode pads at a main surface on a rear end side thereof;
a plurality of plate-shaped metal terminals electrically connected to the respective electrode pads; and
a separator having a storage portion which penetrates the separator in the axial-line direction and in which the rear end side of the sensor element and the metal terminals are stored, thus retaining the metal terminals, wherein
the plurality of electrode pads and the plurality of metal terminals are arranged separately from each other in a width direction of the sensor element, and
a vibration inhibiting member is provided so as to be close to or in contact with radially inner sides of the metal terminals while including an axis of the separator, as seen in the axial-line direction.

2. The gas sensor according to claim 1, wherein
the storage portion has a diameter-expanding portion whose diameter expands toward a direction perpendicular to the main surface as approaching a rearward-facing surface of the separator, and
the vibration inhibiting member is provided on an inner side of the diameter-expanding portion.

3. A gas sensor comprising:
a plate-shaped sensor element extending in an axial-line direction and having a plurality of electrode pads at a main surface on a rear end side thereof;
a plurality of plate-shaped metal terminals electrically connected to the respective electrode pads;
a separator having a storage portion which penetrates the separator in the axial-line direction and in which the rear end side of the sensor element and the metal terminals are stored, thus retaining the metal terminals; and
an elastic grommet provided on a rear end side of the separator separately from the separator, wherein
the grommet has a grommet hole in which rear ends of the metal terminals and lead wires connected to the rear ends are inserted,
the plurality of electrode pads and the plurality of metal terminals are arranged separately from each other in a width direction of the sensor element, and
a vibration inhibiting member is provided, between the separator and the grommet, so as to be close to or in contact with radially inner sides of the metal terminals while including an axis of the separator, as seen in the axial-line direction.

4. The gas sensor according to claim 3, wherein
the storage portion has a diameter-expanding portion whose diameter expands toward a direction perpendicular to the main surface as approaching a rearward-facing surface of the separator.

5. The gas sensor according to claim 1, wherein
a radially-outward-facing surface of the vibration inhibiting member contacts with the radially inner sides of the metal terminals.

6. The gas sensor according to claim 3, wherein
a radially-outward-facing surface of the vibration inhibiting member contacts with the radially inner sides of the metal terminals.

7. The gas sensor according to claim 2, wherein
the diameter-expanding portion has storage grooves which extend in the axial-line direction and in which the metal terminals are respectively stored,
a radially-outward-facing surface of the vibration inhibiting member has projections at respective positions corresponding to the storage grooves, and
the projections are put into the storage grooves, and the metal terminals are respectively retained between the projections and the storage grooves.

8. The gas sensor according to claim 4, wherein
the diameter-expanding portion has storage grooves which extend in the axial-line direction and in which the metal terminals are respectively stored,
a radially-outward-facing surface of the vibration inhibiting member has projections at respective positions corresponding to the storage grooves, and
the projections are put into the storage grooves, and the metal terminals are respectively retained between the projections and the storage grooves.

9. The gas sensor according to claim 2, wherein
a radially-outward-facing surface of the vibration inhibiting member has, at least partially, a taper shape whose diameter expands toward a rear end side along the diameter-expanding portion.

10. The gas sensor according to claim 4, wherein
a radially-outward-facing surface of the vibration inhibiting member has, at least partially, a taper shape whose diameter expands toward a rear end side along the diameter-expanding portion.

11. The gas sensor according to claim 1, wherein
a radially-outward-facing surface of the vibration inhibiting member has recesses in which the metal terminals are respectively stored.

12. The gas sensor according to claim 3, wherein
a radially-outward-facing surface of the vibration inhibiting member has, at least partially, a taper shape whose diameter expands toward a rear end side along the diameter-expanding portion.
